(19) United States
(12) Patent Application Publication
(10) Pub. No.: US 2023/0357534 A1
(43) Pub. Date: Nov. 9, 2023

(54) FLAME RETARDANT WOOD PLASTIC COMPOSITE TO PASS SMOKE TEST AND METHOD OF MAKING

(71) Applicant: Wilsonart LLC, Austin, TX (US)

(72) Inventor: Mahesh Subramanian, Centerville, OH (US)

(21) Appl. No.: 18/311,641

(22) Filed: May 3, 2023

Related U.S. Application Data
(60) Provisional application No. 63/364,086, filed on May 3, 2022.

(51) Int. Cl. C08L 57/00; C08K 3/04; C08K 3/016; C08K 5/00

(52) U.S. Cl. CPC C08K 3/016; C08K 3/04; C08K 5/0091; C08L 57/00; C08L 2201/02; C08L 2205/16

(57) ABSTRACT

A wood-plastic composite panel provides a low smoke index when a flame-retardant laminate is bonded thereto, while also stopping formation and propagation of flames. The wood-plastic composite used in the manufacture of the panel includes wood flour/wood fiber, a thermoplastic material, a cross-linking agent, a lubricant, an accelerator, an inhibitor, an enhancer, a compatibilizer, a blowing agent, and a flame-retardant additive.

### CROSS REFERENCE TO RELATED APPLICATION

This application claims the benefit of U.S. Provisional Pat. Application No. 63/364,086, entitled “FLAME RETARDANT WOOD PLASTIC COMPOSITE TO PASS SMOKE TEST AND METHOD OF MAKING,” filed May 3, 2022, which is incorporated herein by reference.

### BACKGROUND OF THE INVENTION

### 1. Field of the Invention

The current invention relates to flame-retardant wood plastic composites used in the manufacture of panels.

### 2. Description of the Related Art

Wood plastic composite panels are commonly used in various settings. It is important that these panels offer excellent flame-retardant characteristics. Traditional wood plastic composite panels offer good flame spread index, but the wood plastic composite panels have a high smoke index when subject to a flaming source.

### SUMMARY

In one aspect a wood-plastic composite used in the manufacture of a panel provides a low smoke index when a flame-retardant laminate is bonded thereto, while also stopping formation and propagation of flames. The wood-plastic composite comprises wood flour/wood fiber, a thermoplastic material, a cross-linking agent, a lubricant, an accelerator, an inhibitor, an enhancer, a compatibilizer, a blowing agent, and a flame-retardant additive.

In some embodiments the wood-plastic composite includes 0%-5% weight percent of the wood flour/wood fiber, 3%-10% weight percent of the thermoplastic material, 0.01%-5% weight percent of the cross-linking agent, 0.01%-5% weight percent of the lubricant, 0.01%-5% weight percent of the accelerator, 0.01%-5% weight percent of the inhibitor, 0.01%-5% weight percent of the enhancer, 0.01%-5% weight percent of the compatibilizer, 0.01%-5% weight percent of the blowing agent, 40%-48% weight percent of the flame retardant additive, and 1%-10% weight percent of additional char and gas absorber.

In some embodiments the wood flour/wood fiber is selected from the group consisting of sawdust, newspapers, alfalfa, wheat pulp, wood chips, wood fibers, wood particles, ground wood, wood flour, wood flakes, wood veneers, wood laminates, paper, cardboard, straw, cotton, rice hulls, coconut shells, peanut shells, plant fibers, bamboo or palm fiber, bagasse, and kenaf.

In some embodiments the wood flour/wood fiber is dried to a low moisture content.

In some embodiments the moisture content is between about 1%-10%.

In some embodiments the thermoplastic material is selected from the group consisting of polyethylene, polypropylene, polyvinyl chloride, or polylactic acid, low density polyethylene, ethyl-vinyl acetate, other polyethylene copolymers, and other thermoplastics.

In some embodiments the cross-linking agent is selected from the group consisting of polyurethanes, such as isocyanate, phenolic resins, unsaturated polyesters, epoxy resins, and combinations thereof.

In some embodiments the lubricant is zinc stearate or wax.

In some embodiments the flame-retardant additive comprises various combinations of Alumina Trihydrate, Zinc Borate, Zinc Stearate, or Molybdenum/oxide.

In some embodiments the flame-retardant additive also include Magnesium Hydroxide, Calcium or Aluminum Hypophosphite porous hydrated lime, and/or expanding graphite flake.

In some embodiments the wood-plastic composite further includes a partially hydrated magnesium-calcium carbonate and/or a spherical alumina engineered from aluminium oxide to increase enhancement of flame retardancy as synergistic natural minerals to increase temperature resistance to flame.

In some embodiments the flame-retardant additive comprises 15 wt. % Magnesium Hydroxide, 15 wt. % Alumina Trihydrate, 10 wt. % Zinc Borate, and 1 wt. % Zinc Stannate.

In some embodiments the flame-retardant additive comprises 30 wt. % Alumina Trihydrate, 10 wt. % Zinc Borate, and 1 wt. % Zinc Stannate.

In some embodiments the flame-retardant additive comprises 32-34 wt. % Alumina Trihydrate, 9-12 wt. % Zinc Borate, and 1 wt. % Zinc Stannate.

Other objects and advantages of the present invention will become apparent from the following detailed description when viewed in conjunction with the accompanying drawings, which set forth certain embodiments of the invention.

### DESCRIPTION

The detailed embodiments are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to make and/or use the invention.

According to the present invention, a wood-plastic composite panel comprising the wood-plastic composite of the present invention provides a low smoke index when a flame-retardant laminate is bonded thereto, while also stopping the formation and propagation of flames. While the use of flame-retardant laminates and specific types of glue might help in reducing the formation of char on the surface of panels, the present wood-plastic composite enhances the overall characteristics of flame retardancy when panels made therefrom are used as substrates for decorative laminates.

The wood plastic composite in accordance with the present invention includes a mixture of wood flour/wood fiber, thermoplastic materials, cross-linking agents, lubricants, accelerators, inhibitors, enhancers, compatibilizers, and blowing agents. The various elements are combined and molded to form the resulting flame-retardant wood plastic composite panel using conventional processing techniques. The wood-plastic composite also includes additives enhancing the flame-retardant characteristics of the wood-plastic composite.

The wood plastic composite includes the following components:

| | |
|---|---|
| wood flour/wood fiber | 0%-5% weight percent |
| thermoplastic process materials | 3%-10% weight percent |
| cross-linking agents | 0.01%-5% weight percent |
| lubricants (internal/external) | 0.01%-5% weight percent |
| accelerators | 0.01%-5% weight percent |
| inhibitors | 0.01%-5% weight percent |
| enhancers | 0.01%-5% weight percent |
| compatibilizers | 0.01%-5% weight percent |
| blowing agents | 0.01%-5% weight percent |
| flame retardant additive | 40%-48% weight percent |
| Additional Char and gas absorbers | 1%-10% weight percent |

The wood flour/wood fiber may take a variety of forms including sawdust, newspapers, alfalfa, wheat pulp, wood chips, wood fibers, wood particles, ground wood, wood flour, wood flakes, wood veneers, wood laminates, paper, cardboard, straw, cotton, rice hulls, coconut shells, peanut shells, plant fibers, bamboo or palm fiber, bagasse, and kenaf. The wood flour/wood fiber is first dried to a low moisture content. Although not critical, a moisture content of about 1%-10% is preferred. For flame retardant materials it may not be necessary to reduce the moisture content as noted above.

The thermoplastic materials may include materials such as polyethylene, polypropylene, polyvinyl chloride, or polylactic acid, low density polyethylene (LDPE), ethyl-vinyl acetate, other polyethylene copolymers, and other thermoplastics. Examples of cross-linking agents include polyurethanes, such as isocyanate, phenolic resins, unsaturated polyesters, epoxy resins, and combinations thereof. Lubricants, for example, zinc Stearate or wax, may be added as a process aid. Other materials known to the art, for example, inhibitors, enhancers, compatibilizers and blowing agents, may be added.

The flame-retardant additive may be composed of various combinations of Alumina Trihydrate (ATH), Zinc Borate, Zinc Stearate or Molybdenum /oxide. The flame-retardant additive may also include Magnesium Hydroxide (MDH), Calcium or Aluminum Hypophosphite porous hydrated lime (e.g., Sorbacal SPS-10 to aid absorption of HCl produced in flame process), and/or 2 to 5 wt. % expanding graphite flake (where an activating temperature above 175° C. is desired). Additionally compositions such as SECUROC® (a partially hydrated magnesium-calcium carbonate from Sibelco NV Corporation) BORATHERMTM (a spherical alumina engineered from aluminium oxide from Sibelco NV Corporation) can be used to increase enhancement of flame retardancy as synergistic natural minerals to increase temperature resistance to flame to 700° C.

Specific exemplary flame-retardant additive formulations (wt. % of the entire wood plastic composite), are presented below:
15 wt. % MDH + 15 wt. % ATH + 10 wt. % Zinc Borate + 1 wt. % Zinc Stannate
30 wt. % ATH + 10 wt. % Zinc Borate + 1 wt. % Zinc Stannate
32-34 wt. % ATH + 9-12 wt. % Zinc Borate + 1 wt. % Zinc Stannate

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A wood-plastic composite used in manufacture of panels providing a low smoke index when a flame-retardant laminate is bonded thereto, while also stopping formation and propagation of flames, comprising:
wood flour/wood fiber;
a thermoplastic material;
a cross-linking agent;
a lubricant;
an accelerator;
an inhibitor;
an enhancer;
a compatibilizer;
a blowing agent; and
a flame-retardant additive.

2. The wood-plastic composite according to claim 1, wherein the wood plastic composite includes 0%-5% weight percent of the wood flour/wood fiber, 3%-10% weight percent of the thermoplastic material, 0.01%-5% weight percent of the cross-linking agent, 0.01%-5% weight percent of the lubricant, 0.01%-5% weight percent of the accelerator, 0.01%-5% weight percent of the inhibitor, 0.01%-5% weight percent of the enhancer, 0.01%-5% weight percent of the compatibilizer, 0.01%-5% weight percent of the blowing agent, 40%-48% weight percent of the flame retardant additive, and 1%-10% weight percent of additional char and gas absorber.

3. The wood-plastic composite according to claim 1, wherein the wood flour/wood fiber is selected from the group consisting of sawdust, newspapers, alfalfa, wheat pulp, wood chips, wood fibers, wood particles, ground wood, wood flour, wood flakes, wood veneers, wood laminates, paper, cardboard, straw, cotton, rice hulls, coconut shells, peanut shells, plant fibers, bamboo or palm fiber, bagasse, and kenaf.

4. The wood-plastic composite according to claim 3, wherein the wood flour/wood fiber is dried to a low moisture content.

5. The wood-plastic composite according to claim 4, wherein the moisture content is between about 1%-10%.

6. The wood-plastic composite according to claim 1, wherein the thermoplastic material is selected from the group consisting of polyethylene, polypropylene, polyvinyl chloride, or polylactic acid, low density polyethylene, ethyl-vinyl acetate, other polyethylene copolymers, and other thermoplastics.

7. The wood-plastic composite according to claim 1, wherein the cross-linking agent is selected from the group consisting of polyurethanes, such as isocyanate, phenolic resins, unsaturated polyesters, epoxy resins, and combinations thereof.

8. The wood-plastic composite according to claim 1, wherein the lubricant is zinc stearate or wax.

9. The wood-plastic composite according to claim 1, wherein the flame-retardant additive comprises various combinations of Alumina Trihydrate, Zinc Borate, Zinc Stearate, or Molybdenum/oxide.

10. The wood-plastic composite according to claim 9, wherein the flame retardant additive also include Magnesium Hydroxide, Calcium or Aluminum Hypophosphite porous hydrated lime, and/or expanding graphite flake.

11. The wood-plastic composite according to claim 9, further including a partially hydrated magnesium-calcium carbonate and/or a spherical alumina engineered from aluminium oxide to increase enhancement of flame retardancy as synergistic natural minerals to increase temperature resistance to flame.

12. The wood-plastic composite according to claim 1, wherein the flame-retardant additive comprises 15 wt. % Magnesium Hydroxide, 15 wt. % Alumina Trihydrate, 10 wt. % Zinc Borate, and 1 wt. % Zinc Stannate.

13. The wood-plastic composite according to claim 12, wherein the wood flour/wood fiber is selected from the group consisting of sawdust, newspapers, alfalfa, wheat pulp, wood chips, wood fibers, wood particles, ground wood, wood flour, wood flakes, wood veneers, wood laminates, paper, cardboard, straw, cotton, rice hulls, coconut shells, peanut shells, plant fibers, bamboo or palm fiber, bagasse, and kenaf.

14. The wood-plastic composite according to claim 12, wherein the thermoplastic material is selected from the group consisting of polyethylene, polypropylene, polyvinyl chloride, or polylactic acid, low density polyethylene, ethyl-vinyl acetate, other polyethylene copolymers, and other thermoplastics.

15. The wood-plastic composite according to claim 1, wherein the flame-retardant additive comprises 30 wt. % Alumina Trihydrate, 10 wt. % Zinc Borate, and 1 wt. % Zinc Stannate.

16. The wood-plastic composite according to claim 15, wherein the wood flour/wood fiber is selected from the group consisting of sawdust, newspapers, alfalfa, wheat pulp, wood chips, wood fibers, wood particles, ground wood, wood flour, wood flakes, wood veneers, wood laminates, paper, cardboard, straw, cotton, rice hulls, coconut shells, peanut shells, plant fibers, bamboo or palm fiber, bagasse, and kenaf.

17. The wood-plastic composite according to claim 15, wherein the thermoplastic material is selected from the group consisting of polyethylene, polypropylene, polyvinyl chloride, or polylactic acid, low density polyethylene, ethyl-vinyl acetate, other polyethylene copolymers, and other thermoplastics.

18. The wood-plastic composite according to claim 1, wherein the flame-retardant additive comprises 32-34 wt. % Alumina Trihydrate, 9-12 wt. % Zinc Borate, and 1 wt. % Zinc Stannate.

19. The wood-plastic composite according to claim 18, wherein the wood flour/wood fiber is selected from the group consisting of sawdust, newspapers, alfalfa, wheat pulp, wood chips, wood fibers, wood particles, ground wood, wood flour, wood flakes, wood veneers, wood laminates, paper, cardboard, straw, cotton, rice hulls, coconut shells, peanut shells, plant fibers, bamboo or palm fiber, bagasse, and kenaf.

20. The wood-plastic composite according to claim 18, wherein the thermoplastic material is selected from the group consisting of polyethylene, polypropylene, polyvinyl chloride, or polylactic acid, low density polyethylene, ethyl-vinyl acetate, other polyethylene copolymers, and other thermoplastics.
